(19) United States
(12) Patent Application Publication
(10) Pub. No.: US 2026/0316234 A1
(43) Pub. Date: Oct. 15, 2026

(54) Elevator Gib Fastener

(71) Applicant: Kevin Franklin Hume, SR., Houston, TX (US)

(72) Inventor: Kevin Franklin Hume, SR., Houston, TX (US)

(73) Assignee: Kevin Franklin Hume, SR., Houston, TX (US)

(21) Appl. No.: 19/177,555

(22) Filed: Apr. 12, 2025

(51) Int. Cl. B25B 23/00; B25B 13/48; B66B 13/30

(52) U.S. Cl. CPC B25B 23/0085; B66B 13/301; B25B 13/481

(57) ABSTRACT

A mechanical fastening tool for securing elevator door gibs to a chassis using a single operator and a single actuator tool. The tool comprises a rigid structure having three angled surfaces configured to engage a threaded stud, support the gib, and counteract rotational torque applied during fastening. The invention enables one-handed operation, increases safety, reduces labor, and accommodates varying gib geometries without the use of dual screwdrivers or second technician assistance.

### CROSS-REFERENCE TO RELATED APPLICATIONS

None.

### BACKGROUND OF THE INVENTION

### Field of the Invention

The present invention relates generally to the field of mechanical tools and fastener engagement systems and, more specifically, to a fastening apparatus for use in elevator installation and maintenance, particularly for securing elevator door gibs to an elevator chassis using a single tool and single operator without the need for opposing fasteners or dual screwdrivers.

### Description of Related Art

Conventional elevator door gibs are typically fastened to the elevator door chassis using threaded hardware, such as a threaded stud with a slot for a flat head screwdriver at the bottom, which requires a technician to simultaneously secure the stud on one side of the assembly while applying torque to the bolt from the opposite side. This method necessitates the use of two tools (e.g., screwdrivers or wrenches) and often the presence of a second technician, especially when the components are recessed or otherwise inaccessible from a single position.

This dual-operation setup presents ergonomic and safety concerns, particularly in confined elevator shafts or during over-the-head installations. Furthermore, current methods are time-consuming, error-prone, and increase the likelihood of improper fastener torque or misalignment.

There is a need in the art for a tool that simplifies the gib fastening procedure while maintaining structural integrity, safety, and speed of installation.

### SUMMARY OF THE INVENTION

The present invention provides a mechanical fastening apparatus for securing elevator door gibs to the elevator chassis using a single operator and a single tool. The invention eliminates the need to access both sides of the gib-chassis interface by employing an integrated geometry that maintains the fastener or stud in a fixed position via mechanical leverage, allowing torque to be applied from the accessible side only.

The fastening apparatus comprises a rigid body formed from a single planar sheet of tool-grade material, bent or machined to produce a set of three orthogonal surfaces. A first contact surface engages a lower portion of a threaded stud or nut, a second surface serves as a structural brace, and a third surface applies force against the gib or adjacent surface, maintaining the position of the fastener through opposing mechanical force vectors. The device may include dimensional variations, cutouts, or optional inserts to accommodate different gib configurations and screw types.

Embodiments may include fixed or adjustable jaws, interchangeable inserts, or optional magnetic retention features. The invention also contemplates methods of manufacture using laser cutting, forging, or CNC machining.

### BRIEF DESCRIPTION OF THE DRAWINGS

FIG. 1: Three-dimensional view with dimensional annotations and angle identifications.

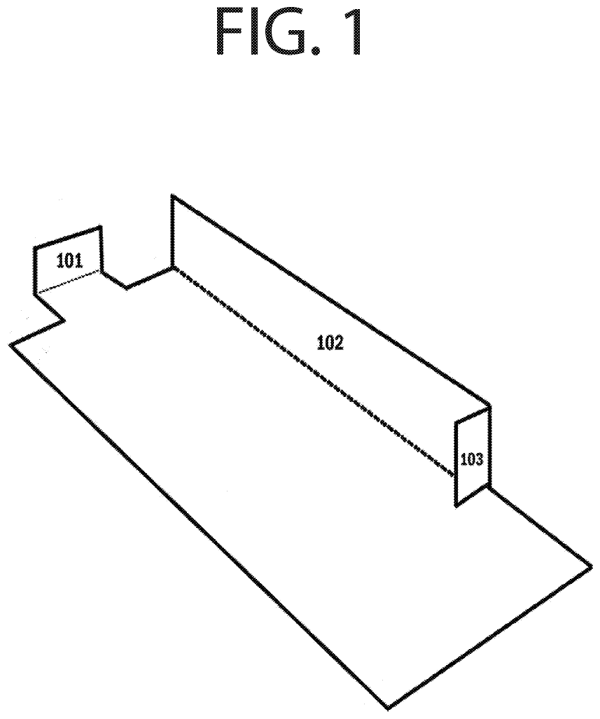

### DETAILED DESCRIPTION OF THE INVENTION

### Tool Structure and Components

Referring now to the figure, the fastening tool comprises a monolithic or assembled structure formed of at least three integrally-formed angular segments:
A first segment 101, hereinafter referred to as the “stud interface arm,” comprises a concave or planar seat dimensioned to engage and restrain rotational movement of a threaded stud or similar fastener.
A second segment 102, disposed at approximately 90 degrees to the first, acts as a load-bearing brace or structural transition region.
A third segment 103, further bent at a 90-degree angle from the second segment, comprises a bearing surface configured to rest against or press into the side of an elevator door gib or the chassis surface adjacent to the gib.

The force applied at segment 103 opposes the reactionary torque generated during the fastening operation, thereby retaining the threaded stud in a substantially rotationally fixed condition.

### Materials and Manufacturing

The tool may be fabricated from tool-grade carbon steel, stainless steel, or alloy composites capable of withstanding torsional and compressive loads. Preferred thickness ranges from 2 mm to 6 mm, depending on the expected torque profile.

Forming methods include press braking, CNC machining, laser cutting, stamping, or forging. Optional surface treatments may include powder coating, nitriding, or anti-corrosion plating.

### Method of Operation

1. Insert the threaded stud through the elevator door gib and corresponding hole in the elevator door chassis.
2. Engage the stud interface arm (102) of the tool with the bottom or lower portion of the threaded stud.
3. Position the third segment (106) against the gib surface such that the applied torque to the screw from above is counteracted by the reactive force of the tool's structural geometry.
4. Apply torque from above to secure the fastener; the tool maintains the stud in place without rotational movement.
5. Once the fastener is fully engaged, disengage and remove the tool.

### ADVANTAGES OF THE INVENTION

Eliminates the need for two screwdrivers or a second technician.
Enables one-handed operation in confined spaces.
Increases safety by eliminating hand slippage and tool juggling.
Reduces installation time by up to 50%.
Accommodates a variety of gib geometries and fastener types.

What is claimed is:

1. A fastening tool for securing elevator door gibs to a chassis, comprising: a monolithic or assembled body including: a first planar segment configured to engage a threaded stud or similar fastener; a second segment extending at an angle of approximately 90 degrees from the first segment and providing structural reinforcement; a third segment extending at an angle of approximately 90 degrees from the second segment, the third segment configured to press against a gib or chassis surface such that applied torque to the fastener from above is counteracted by the tool's engagement with the gib and chassis.

2. The tool of claim 1, wherein the first segment includes a concavity or groove dimensioned to partially encompass the threaded stud.

3. The tool of claim 1, wherein the third segment is configured to distribute force across the face of the gib without damaging the gib material.

4. The tool of claim 1, wherein the tool is fabricated from a single planar sheet of tool-grade steel.

5. The tool of claim 1, further comprising an interchangeable insert attached to the first segment to accommodate variable stud geometries.

6. The tool of claim 1, further comprising a magnetic or mechanical fastener retainer positioned on the first segment.

7. The tool of claim 1, wherein the tool is reversible and operable in either a vertical or horizontal orientation.

8. The tool of claim 1, wherein the first and third segments are offset laterally to provide clearance for obstructions adjacent to the chassis.

9. A method for securing an elevator door gib to a chassis, comprising: inserting a threaded stud through the gib and chassis; positioning a fastening tool in accordance with claim 1 such that the first segment engages the stud and the third segment presses against the gib; applying torque from above to secure a screw into the threaded stud while the tool maintains the stud in a non-rotating state.

10. The method of claim 9, wherein the tool is removed after the threaded fastener is fully engaged.
